(19) United States
(12) Patent Application Publication
(10) Pub. No.: US 2011/0115428 A1
(43) Pub. Date: May 19, 2011

(54) Method and apparatus for charging

(75) Inventor: Heui Do Lim, Suwon-si (KR)

(73) Assignee: Samsung Electronics Co., Ltd., Suwon-si (KR)

(21) Appl. No.: 12/925,748

(22) Filed: Oct. 28, 2010

(30) Foreign Application Priority Data
Nov. 18, 2009 (KR) 10-2009-0111566

(51) Int. Cl. H02J 7/04; H02J 7/00

(52) U.S. Cl. 320/107; 320/162

(57) ABSTRACT

A charge apparatus and a method thereof are provided. A charge apparatus includes a charge management unit configured to gradually amplify and transfer a supply current to correspond with a reference current value when an electric current is supplied; and a power charging unit configured to accumulate the transferred current.

### CROSS-REFERENCE TO RELATED APPLICATION(S) AND CLAIM OF PRIORITY

The present application claims the benefit under 35 U.S.C. §119(a) to a Korean patent application filed in the Korean Intellectual Property Office on Nov. 18, 2009 and assigned Serial No. 10-2009-0111566, the entire disclosure of which is hereby incorporated by reference.

### TECHNICAL FIELD OF THE INVENTION

The present invention relates to a mobile terminal and a method for operating the same, and more particularly, to a charge apparatus of a mobile terminal and a method thereof.

### BACKGROUND OF THE INVENTION

In general, a mobile terminal has various functions to perform multi-function. Further, the mobile terminal is implemented to process large amounts of data. The mobile terminal includes a battery therein and operates using energy stored in the battery. In addition, the mobile terminal is implemented to be easily carried by a user. In recent years, since the mobile terminal has an integrated circuit (IC) that charges the battery, the mobile terminal may charge the battery without a separate external device. In this case, the mobile terminal amplifies an external current by a given value and charges a battery with the amplified current. Here, the amount of electric current that charges the battery is determined by an IC and a resistor connected thereto. The mobile terminal amplifies an electric current using the IC and the resistor.

However, upon applying an external current to the IC, a voltage drop occurs in a conventional mobile terminal as mentioned above. Namely, as the external current is transferred to a resistor through the IC, a voltage drop occurs in the mobile terminal corresponding to a resistance value previously set in the resistor. As a result, an erroneous operation may occur due to the voltage drop, and resource consumption can increase.

### SUMMARY OF THE INVENTION

To address the above-discussed deficiencies of the prior art, it is a primary object to provide a charge apparatus and a method.

In accordance with an aspect of the present invention, a charge apparatus includes: a charge management unit configured to gradually amplify and transfer a supply current corresponding to a reference current value when an electric current is supplied; and a power charging unit configured to accumulate the transferred current.

The charge management unit includes: a current controller including an adjusting capacitor configured to accumulate the supply current when the electric current is supplied and discharge the accumulated current when the supply current is fully charged, and an adjusting resistor connected in parallel with the adjusting capacitor and configured to varya resistance value according to the discharged current; and a charging circuit to amplify the supply current according to the resistance value.

The charge management unit further includes: a charging controller configured to set an output voltage value of a first terminal of the current controller opposite a second terminal of the current controller to exceed an input voltage value of the second terminal of the current controller receiving the supplied current, control the supplied current to be inputted to the second terminal of the current controller and to be accumulated in the adjusting capacitor, when the electric current is supplied.

In accordance with another aspect of the present invention, a charge method includes: gradually amplifying a supply current to correspond with a reference current value; and accumulating the amplified current.

Gradually amplifying a supply current includes: accumulating the supply current in an adjusting capacitor; discharging the accumulated current from the adjusting capacitor to an adjusting resistor connected in parallel with the adjusting capacitor when the supply current is fully charged to vary a resistance value in the adjusting resistor; and amplifying the supply current according the resistance value.

A charge apparatus and a method thereof according to the present invention gradually amplify an input current value over time by gradually varying a resistance value over time during a given time interval from a charging start time, and a method thereof. This suppresses the occurrence of a voltage drop in the charge apparatus at a charging start time. This also may suppress the occurrence of an erroneous operation due to the voltage drop and resource consumption.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating an internal configuration of a charge apparatus according to an exemplary embodiment of the present invention;

FIG. 2 is block diagrams illustrating a detailed configuration of a current controller shown in FIG. 1;

FIG. 3 is a flow diagram illustrating a charging procedure of a charge apparatus according to an exemplary embodiment of the present invention; and

FIG. 4 is graphs illustrating operating characteristics of a charge apparatus according to an exemplary embodiment of the present invention.

### DETAILED DESCRIPTION OF THE INVENTION

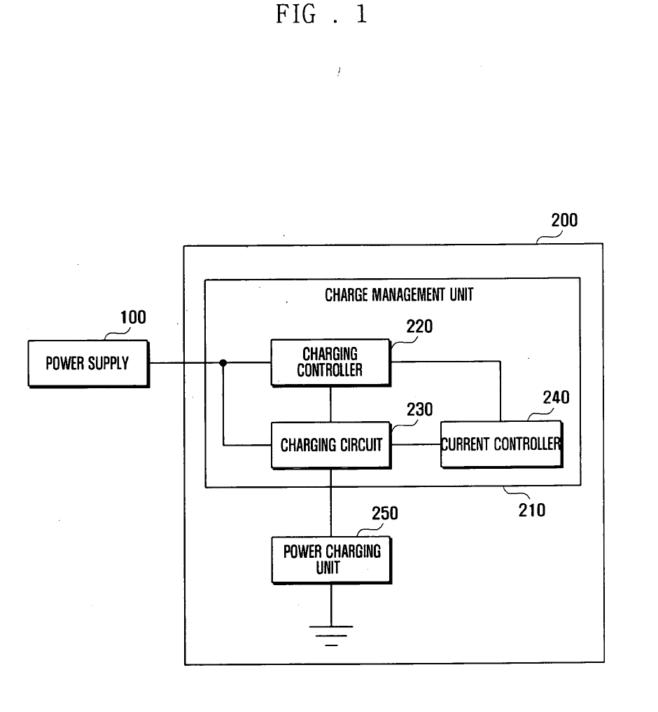

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged charge apparatus. Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

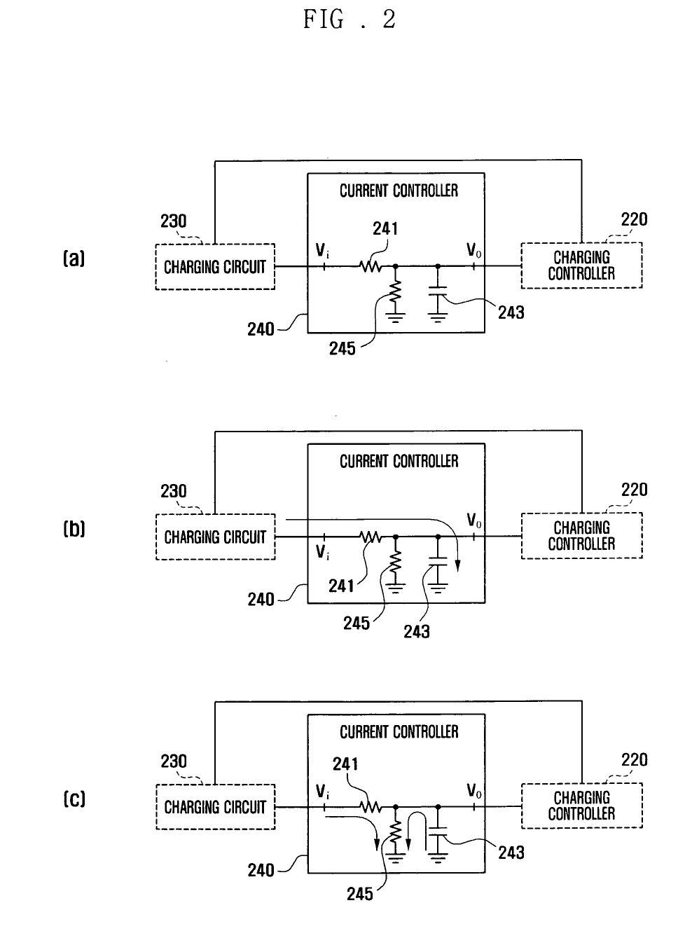

FIG. 1 is a block diagram illustrating an internal configuration of a charge apparatus according to an exemplary embodiment of the present invention, and FIG. 2 is block diagrams illustrating a detailed configuration of a current controller shown in FIG. 1. In this case, the charge apparatus of this embodiment can be mounted in a mobile terminal.

Referring to FIG. 1, the charge apparatus 200 of the present embodiment may connect with a power supply 100. The charge apparatus of the embodiment includes a charge management unit 210 and a power charging unit 250.

The power supply 100 supplies power to the charge apparatus 200. The power supply 100 may be an external power source device or a travel adaptor (TA) connecting with a separate external power source device. In this case, the power supply 100 supplies power corresponding to a given input current value Iᵢ and input voltage value Vᵢ. Namely, when the power supply 100 connects with the charge apparatus 200, the power supply 100 supplies power to the charge apparatus 200.

The charge management unit 210 performs a power management function of the charge apparatus 200. Here, the charge management unit 210 may be a power management integrated circuit (PMIC). The charge management unit 210 converts and sends external power. In this case, the charge management unit 210 amplifies and sends an external current by a given value. Namely, when the power supply 100 supplies an electric current to the charge management unit 210, the charge management unit 210 amplifies an input current value Iᵢ to a given reference current value Iᵣ. To do this, the charge management unit 210 includes a charging controller 220, a charging circuit 230, and a current controller 240.

The charging controller 220 performs a control function in the charge management unit 210. The charging controller 220 determines charging execution according to the presence of a connection with the power supply 100. Namely, upon connection with the power supply 100, the charging controller 220 starts charging. Further, upon charging execution, the charging controller 220 sets the occurrence of a voltage difference of a given width at both terminals of the current controller 240. Meanwhile, upon cancelling connection with the power supply 100, the charging controller 220 stops the charging. At this time, the charging controller 220 may control the charge management unit 210 using a control signal or an I²C (Inter-IC).

The charging circuit 230 performs conversion and transfer functions in the charge management unit 210. In this case, the charging circuit 230 may be a charging IC. In this case, upon charging execution, the charging circuit 230 provides an electric current to one terminal of the current controller 240, and amplifies and sends an input current value Iᵢ to the power charging unit 250.

A current controller 240 of the charge management unit 210 performs a supporting function with respect to the charging circuit 230. Namely, the current controller 240 amplifies the input current value Iᵢ by cooperating with the charging circuit 230. In this case, the current controller 240 supports a gradual amplification of the input current value Iᵢ over time to correspond with a reference current value. To do this, as shown in FIG. 2, the current controller 240 includes a determinative resistor 241, an adjusting capacitor 243, and an adjusting resistor 245. The adjusting capacitor 243 and the determinative resistor 241 are serially connected to each other in series. The adjusting capacitor 243 and the adjusting resistor 245 are connected in parallel with each other. The adjusting capacitor 243 and the adjusting resistor 245 are grounded.

For example, upon charging execution, as shown in FIG. 2(a), an input voltage value Vᵢ and an output voltage value Vₒ are set at both terminals of the current controller 240, respectively. In this case, in the current controller 240, the output voltage Vₒ is set by the charging controller 220 and the input voltage value Vᵢ is preset by the power supply 100. Here, the charging controller 220 sets the output voltage value Vₒ at another terminal of the current controller 240 exceeding the input voltage value Vᵢ.

Furthermore, when an electric current is introduced through one terminal of the current controller 240, as shown in FIG. 2(b), the adjusting capacitor 243 accumulates the electric current.

That is why the output voltage value Vₒ exceeds the input voltage value Vᵢ but does not exceed an electric current through another terminal of the current controller 240. Namely, a transfer direction of the electric current is formed from one terminal of the current controller 240 to the adjusting capacitor 243. Through this, if the determinative resistor 241 passes the electric current, the electric current is supplied to the adjusting capacitor 243.

In addition, when the electric current is fully charged, as shown in FIG. 2(c), the electric current of the adjusting capacitor 243 is discharged. At this time, the electric current of the adjusting capacitor 243 is discharged through the adjusting resistor 245. That is why the output voltage value Vₒ exceeds the input voltage value Vᵢ but does not exceed an electric current through another terminal of the current controller 240. Namely, a discharging direction of the electric current is formed opposite to the transfer direction of the electric current from one terminal of the current controller 240 to the adjusting capacitor 243. Here, the electric current is continuously introduced through the one terminal of the current controller 240. Through this, the electric current from the determinative resistor 241 is supplied to the adjusting resistor 245, and the electric current is discharged to the adjusting resistor 245 from the adjusting capacitor 243. At this time, a resistance value in the adjusting resistor 245 gradually varies with time by passing an electric current of the adjusting capacitor 243.

Namely, during a given time interval from a charging start time, the current controller 240 gradually varies the resistance value with time. Through this, upon charging execution, the charging circuit 230 and the current controller 240 gradually amplify the input current value Iᵢ over time to correspond with the reference current value Iᵣ according to the resistance value of the current controller 240. Moreover, the charging circuit 230 sends an electric current corresponding to the reference current value Iᵣ to the power charging unit 250.

The power charging unit 250 performs a power storing function in the charge apparatus 200. In this case, the power charging unit 250 may be a battery such as a lithium-ion battery or a lithium-Polymer battery. The power charging unit 250 stores power provided from the charge management unit 210. Namely, when an electric current from the charge management unit 210 is transferred to the power charging unit 250, the power charging unit 250 stores the electric current as the reference current value Iᵣ. Meanwhile, although not shown, the power charging unit 250 may supply power to another arrangement in a mobile terminal.

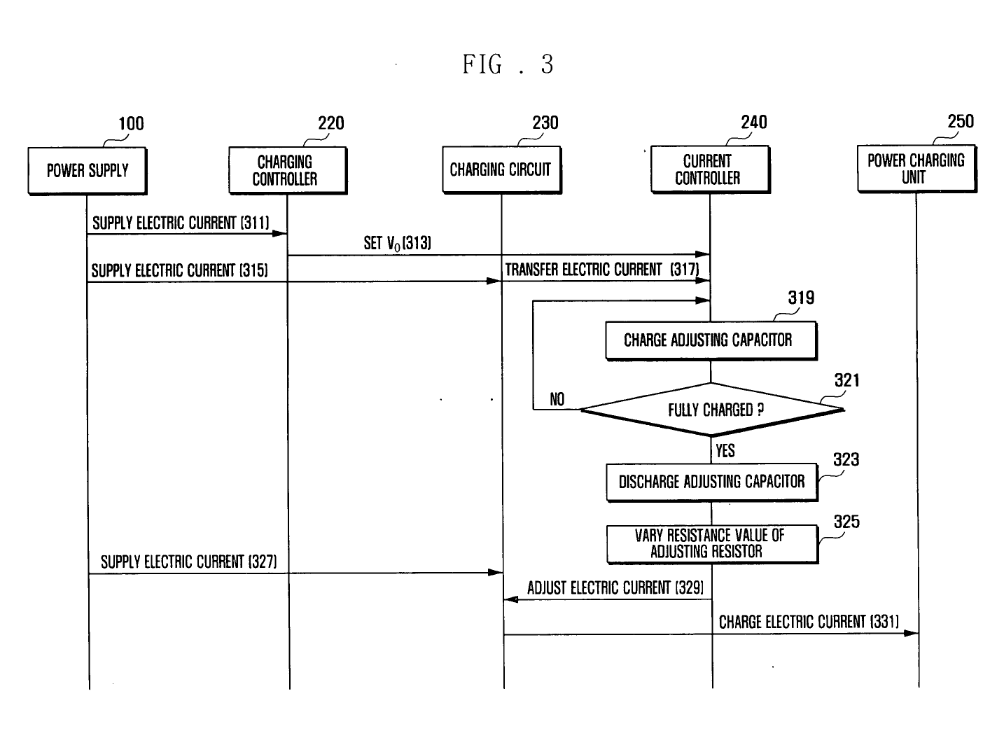

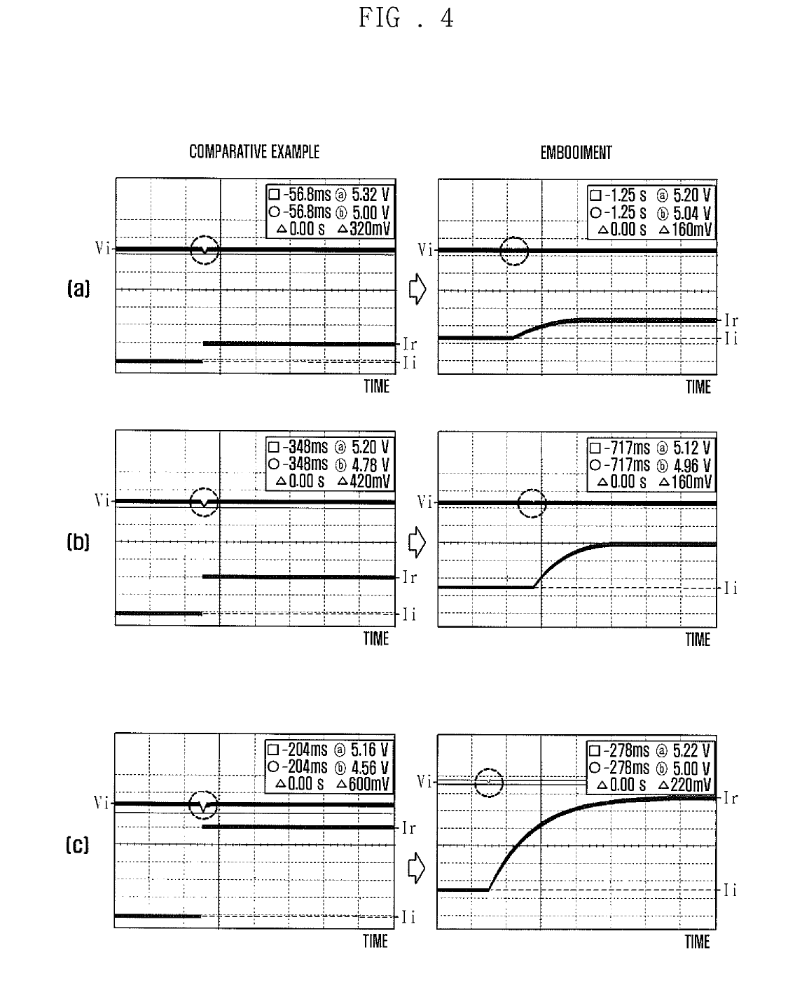

FIG. 3 is a flow diagram illustrating a charging procedure of a charge apparatus according to an exemplary embodiment of the present invention. FIG. 4 is graphs illustrating operating characteristics of a charge apparatus according to an exemplary embodiment of the present invention.

Referring to FIG. 3, a charging procedure of this embodiment starts when a charging controller 220 senses an electric current supplied from a power supply 100 (311). Namely, when the charging controller 220 connects with the power supply 100 and receives supply of an electric current from the power supply 110, the charging controller 220 senses the supply of an electric current to start charging. Further, the charging controller 220 sets the occurrence of a voltage difference with a given width at both terminals of the current controller 240 (313). Namely, the charging controller 220 sets an output voltage value Vₒ at another terminal of the current controller 240. At this time, the charging controller 220 sets the output voltage value Vₒ to exceed an input voltage value Vᵢ.

Next, when an electric current from the power supply 100 is supplied to the charging circuit 230, the charging circuit 230 senses the supplied current (315) and sends the supplied current to the current controller 240 (317). Next, when the electric current is introduced to one terminal of the current controller 240, the current controller 240 charges the adjusting capacitor 243 (319). Namely, the adjusting capacitor 243 of the current controller 240 accumulates the electric current. At this time, when the electric current is introduced to the one terminal of the current controller 240, the electric current is transferred to the adjusting capacitor 243 through a determinative resistor 241.

Then, the current controller 240 checks whether the adjusting capacitor 243 is fully charged (321). When the adjusting capacitor 243 is fully charged, the current controller 240 discharges the adjusting capacitor (323). Namely, the charged current in the adjusting capacitor 243 is discharged in the current controller 240. In this case, the current controller 240 discharges the electric current in the adjusting capacitor 243 to the adjusting resistor 245. Here, when an electric current is introduced to one terminal of the current controller 240, the electric current is transferred to the adjusting resistor 245 through the determinative resistor 241. Subsequently, the current controller 240 varies a resistance value in the adjusting resistor 245 (325). Namely, the adjusting resistor 245 adds the electric current from the adjusting capacitor 243 to the electric current from the charging circuit 230 to transfer a sum of the two electric currents such that the resistance value in the adjusting resistor 245 gradually varies over time.

Finally, an electric current from the power supply 100 is supplied to a charge management unit 210, the charging circuit 230 senses the electric current (327), and adjusts the electric current using the resistance value in the current controller 240 (329). Namely, the charging circuit 230 and the current controller 240 gradually amplifies an input current value Iᵢ over time to correspond with a reference current value Iᵣ. Further, the charging circuit 230 charges the power charging unit 250 with an electric current (331).

For example, in the current controller 240 of an embodiment of the present invention, the determinative resistor 241, the adjusting capacitor 243, and the adjusting resistor 245 may have parameters listed in Table 1. At this time, a case of engaging a fixed resistor with an integrated circuit is suggested as a comparative example. The fixed resistor may have parameters listed in Table 1.

TABLE 1

| | Comparative | | | |
|---|---|---|---|---|
| | example | Embodiment | | |
| | Fixed | Determinative | Adjusting | Adjusting |
| value | resistor | resistor | Resistor | Capacitor |
| 100 mA | 51 kΩ | 27 kΩ | 27 kΩ | 11 μF |
| 200 mA | 27 kΩ | 12 kΩ | 12 kΩ | 11 μF |
| 300 mA | 12 kΩ | 5.6 kΩ | 5.6 kΩ | 11 μF |

In an embodiment of the present invention, as shown in FIG. 4, in comparison with the comparative example, an input current Iᵢ is gradually amplified over time by a current controller 240 in the charge apparatus 200. Accordingly, the occurrence of a voltage drop is suppressed at a charging start time in the charge apparatus 200.

Namely, in the comparative example, the input current Iᵢ is gradually amplified to correspond with a reference current value Iᵣ at the charging start time. Conversely, in an embodiment of the present invention, during a given time interval from a charging start time, the input current Iᵢ is gradually amplified over time to correspond with the reference current value Iᵣ. Due to this amplification, when the input current value Iᵢ is ‘100 mA’, as shown in FIG. 4(a), a voltage drop of about ‘320 mV’ occurs in the comparative example. Conversely, in the same case as the comparative example, a voltage drop of about ‘160 mV’ occurs in an embodiment of the present invention. When the input current value Iᵢ is ‘200 mA’, as shown in FIG. 4(b), a voltage drop of approximately ‘420 mV’ occurs in the comparative example. Conversely, a voltage drop of approximately ‘160 to 180 mV’ occurs in an embodiment of the present invention. When the input current value Iᵢ is ‘300 mA’, as shown in FIG. 4(c), a voltage drop of about ‘600’ mV’ occurs in the comparative example. Conversely, a voltage drop of approximately ‘220 mV’ occurs in an embodiment of the present invention.

Meanwhile, the foregoing embodiment has been described with the charge management unit 210 including the charging circuit 230 and the current controller 240. However, the present invention is not limited thereto. For example, the charging circuit 230 and the current control 240 may be not included in the charge management unit 210 but be configured separately from the charge management unit 210. Namely, the charging circuit 230 and the current controller 240 gradually amplify an input current based on a reference current value over time under the control of the charging controller 220 of the charge management unit 210, thereby implementing the present invention.

In the present invention, a resistance value gradually varies during a given time interval from a charging start time in the charge apparatus, so that an input current value is gradually amplified over time. Due to this, the occurrence of a voltage drop is suppressed at a charging start time in the charge apparatus. Therefore, in a portable terminal having the charge apparatus, the occurrence of an erroneous operation due to a voltage drop and resource consumption can be suppressed.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A charge apparatus, comprising:
a charge management unit configured to gradually amplify and transfer a supply current to correspond with a reference current value when an electric current is supplied; and
a power charging unit configured to accumulate the transferred current.

2. The charge apparatus of claim 1, wherein the charge management unit comprises:
a current controller comprising:
an adjusting capacitor configured to accumulate the supply current when the electric current is supplied and discharge the accumulated current when the supply current is fully charged, and
an adjusting resistor connecting in parallel with the adjusting capacitor and configured to vary a resistance value according to the discharged current; and
a charging circuit configured to amplify the supply current according to the resistance value.

3. The charge apparatus of claim 2, wherein the charge management unit further comprises:
a charging controller configured to set an output voltage value of a first terminal of the current controller opposite a second terminal of the current controller to exceed an input voltage value of the second terminal of the current controller receiving the supplied current, control the supplied current to be inputted to the second terminal of the current controller and to be accumulated in the adjusting capacitor, when the electric current is supplied.

4. The charge apparatus of claim 2, wherein the current controller further comprises a determinative resistor.

5. The charge apparatus of claim 2, wherein the adjusting capacitor and the determinative resistor are connected in series to one another.

6. The charge apparatus of claim 2, wherein the adjusting capacitor and the adjusting resistor are grounded.

7. The charge apparatus of claim 2, wherein the electric current is supplied to the adjusting capacitor when the determinative resistor passes the electric current.

8. A charge method, comprising:
gradually amplifying a supply current to correspond with a reference current value; and
accumulating the amplified current.

9. The charge method of claim 8, wherein gradually amplifying a supply current comprises:
accumulating the supply current in an adjusting capacitor;
discharging the accumulated current from the adjusting capacitor to an adjusting resistor connecting in parallel with the adjusting capacitor when the supply current is fully charged to vary a resistance value in the adjusting resistor; and
amplifying the supply current according the resistance value.

10. The charge method of claim 9, further comprising:
setting an output voltage value of a first terminal of a current controller opposite a second terminal of the current controller to exceed an input voltage value of the second terminal of the current controller receiving the supplied current, control the supplied current to be inputted to the second terminal of the current controller and to be accumulated in the adjusting capacitor, when the electric current is supplied.
